(19) United States
(12) Patent Application Publication
(10) Pub. No.: US 2008/0109479 A1
(43) Pub. Date: May 8, 2008

(54) Advanced Versatile Layout and Rendering System, Method and Product

(75) Inventors: Lewis Cheng, Mountain View, CA (US); Joseph Fusion, Portland, OR (US); Kyung Lee, Fort Lee, NJ (US)

Correspondence Address: Richard L. Samuels;GOODWIN PROCTER, 103 Eisenhower Parkway, Roseland, NJ, 07068, US

(73) Assignee: Plantii USA, Inc.,, San Jose, CA (US)

(21) Appl. No.: 10/551,661

(22) PCT Filed: Apr. 1, 2004
(86) PCT No.: PCT/US04/10027

§ 371 Date: Aug. 17, 2006

Related U.S. Application Data
(60) Provisional application No. 60/459,329, filed on Apr. 1, 2003.

(51) Int. Cl. G06F 17/30

(52) U.S. Cl. 707/104.1; 707/E17.122

(57) ABSTRACT

Provided herein is a system, method and computer program product for effectively arranging and rendering multimedia information using for example, Macromedia's Flash™ technology, the Extensible Markup Language (XML) language and the Mathematical Markup Language (MathML). The invention utilizes question data (301), possible visual aids (305), possible descriptive solutions (307), and element alignment (309).

### CLAIM OF PRIORITY/CROSS REFERENCE OF RELATED APPLICATION(S)

This application claims the benefit of priority of U.S. Provisional Application No. 60/459,329, filed Apr. 1, 2003, entitled “Advanced Versatile Layout and Rendering System,” hereby incorporated in its entirety herein.

### STATEMENT REGARDING FEDERALLY SPONSORED RESEARCH OR DEVELOPMENT

Not applicable.

### COPYRIGHT/TRADEMARK STATEMENT

A portion of the disclosure of this patent document may contain material which is subject to copyright and/or trademark protection. The copyright/trademark owner has no objection to the facsimile reproduction by anyone of the patent document or the patent disclosure, as it appears in the Patent Office patent files or records, but otherwise reserves all copyrights and trademarks.

### BACKGROUND

1. Field of the Invention

The present invention relates generally to graphical rendering systems and more particularly to a system, apparatus, process and article of manufacture for providing improved interactive, graphical applications using, for example, Macromedia Flash™ technology available from Macromedia Inc., the Extensible Markup Language (XML) language and the Mathematical Markup Language (MathML).

Details of Macromedia Flash™ technology, including preferred software and hardware environments, can be found in various sources such as: Macromedia's website, <http://www.macromedia.com>, conference notes from FlashForward and Macromedia Ucon; in several books published, for example by Friends of Ed, O'Reilly & Co. and Macromedia; articles and user forums on websites such as We're Here, FlashKit, UltraShock, and Figleaf's FlashCoders.

Details of XML and MathML, including preferred software and hardware environments, can also be found in various sources including the W3C's website, <http://www.w3c.org>. Specifically, the current MathML specification entitled, “Mathematical Markup Language (MathML) Version 2.0,” is located at <http://www.w3.org/TR/2001/REC-MathML2-20010221>.

Each of the above references and any additional reference provided herein are incorporated in its entirety herein.

2. Description of Related Art

Currently, multimedia information comprising text, graphics, mathematical expressions, symbols and other indicia (collectively, referred to as “mathematical expressions”), etc., is developed and presented as follows:

Current web browsers, e.g., Internet Explorer™, Netscape™, etc., display stylized text and graphics/images however, only a few lesser known web browsers contain native MathML support, thereby limiting use.

Another technique involves manually generating the entire multimedia layout using a graphical creation and rendering program such as Macromedia Flash MX™ development tool by Macromedia, Inc. However, manual layout is acutely impractical due to high development costs and the severe constraints placed on maintainability, scalability and portability.

The Macromedia Flash Player™ and its associated Flash Plug-in™ display stylized text that is formatted as a Hypertext Markup Language (HTML) object. However, such an arrangement offers no integration with graphics or mathematical expressions.

Existing software products display mathematical expressions by rendering MathML objects to a graphical format such as the Joint Photographic Experts Group (JPEG) format. However, to be effective the graphics must be displayed inline with text. Further pre-rendering the graphics or rendering them dynamically to address the preceding requirement is costly in performance, storage and bandwidth, as well as licensing fees.

The present invention solves the aforementioned limitations of the prior art. Specifically, the present invention is a comprehensive solution for effectively arranging and rendering multimedia information comprising mixed data types including: text, graphics, animations, video and mathematical expressions. The mixed data may be displayed in various sizes and formats and is in a portable and maintainable format. In addition, there is support for certain technologies, such as, Macromedia Flash™, multilingual and Unicode support, and client-server n-tier implementations. Furthermore, performance and costs are kept at acceptable levels.

Additional aspects, features and advantages of the present invention will become better understood with regard to the following description.

### BRIEF DESCRIPTION OF THE DRAWING(S)

Referring briefly to the drawings, embodiments of the present invention will be described with reference to the accompanying drawings in which:

FIG. 1A illustrates an exemplary system constructed in accordance with the teachings expressed herein.

FIG. 1B illustrates an exemplary networked system constructed in accordance with the teachings expressed herein.

FIG. 2 illustrates an exemplary data format in accordance with the teachings expressed herein.

FIG. 3 illustrates an exemplary process flow in accordance with the teachings expressed herein.

FIG. 4 illustrates an exemplary psuedo-code listing implementing the embodiment of FIG. 3 in accordance with the teachings expressed herein.

FIG. 5 illustrates an additional and exemplary process flow in accordance with the teachings expressed herein.

FIG. 6 illustrates an exemplary psuedo-code listing implementing the embodiment of FIG. 5 in accordance with the teachings expressed herein.

FIG. 7 illustrates an exemplary user interface in accordance with the teachings expressed herein.

### DETAILED DESCRIPTION OF THE PRESENT INVENTION

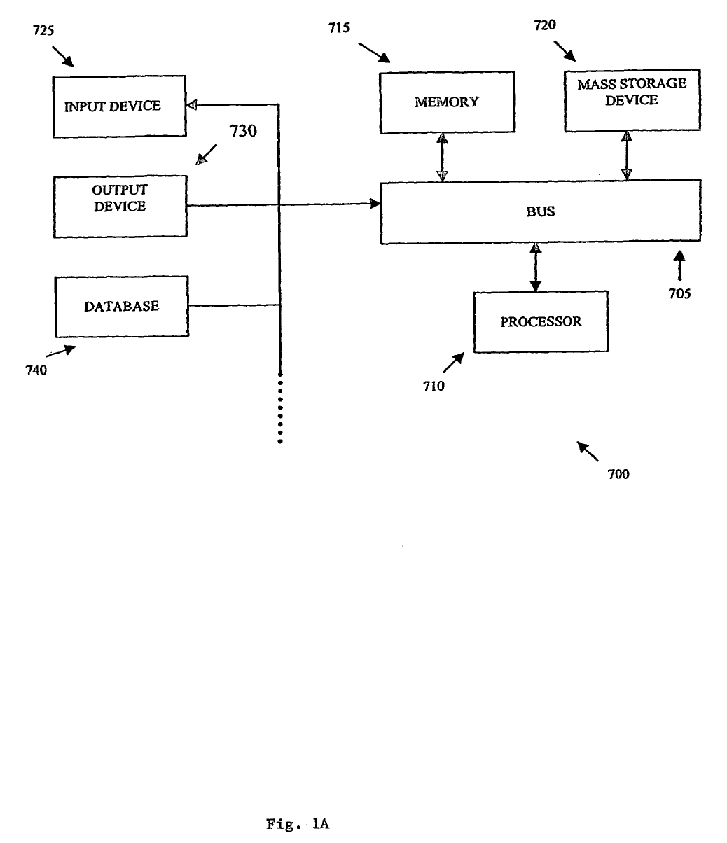

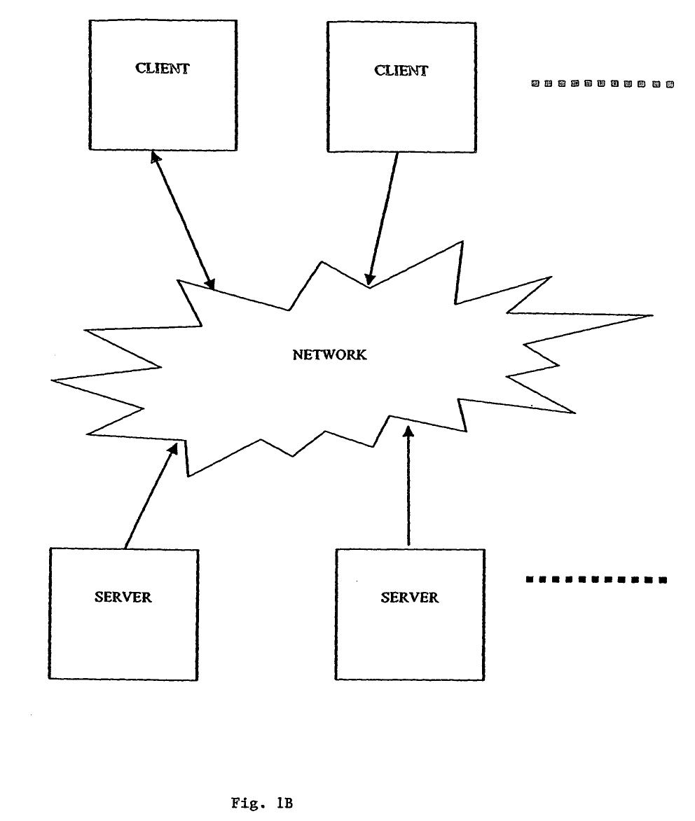

Referring more specifically to the drawings, for illustrative purposes the present invention is embodied in the system configuration, method of operation, data format and application code, generally shown in FIGS. 1-7. Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

It will be appreciated that the system, method of operation, data object and computer product described herein may vary as to the details without departing from the basic concepts disclosed herein. Moreover, numerous specific details are set forth in order to provide a more thorough description of the present invention. However, all specific details may be replaced with generic ones. Furthermore, well-known features have not been described in detail so as not to obfuscate the principles expressed herein. While exemplary embodiments of the present invention described herein is specifically directed to a Macromedia Flash-XML-MathML based environment, the invention is not limited thereby as one skilled in the art can readily adapt the concepts presented herein to a preferred environment. Therefore, other suitable and equivalent programming languages, platforms and architectures, etc. fall within the scope of the present invention.

FIG. 1 illustrates an exemplary hardware configuration of a processor-controlled system on which the present invention is implemented. One skilled in the art will appreciate that the present invention is not limited by the depicted configuration as the present invention may be implemented on any past, present and future configuration, including for example, workstation/desktop/laptop/handheld configurations, client-server configurations, n-tier configurations, distributed configurations, other networked configurations, etc., having the necessary components for carrying out the principles expressed herein.

FIGS. 1A & B generally depict an advanced versatile layout and rendering system 700 in accordance with the teachings expressed herein, comprising, but not limited to, a bus 705 that allows for communication among at least one processor 710, at least one memory 715 and at least one storage device 720. The bus 705 is also coupled to receive inputs from at least one input device 725, e.g., mouse, keyboard, pen, pad, etc., and provide outputs to at least one output device 730, monitor, printer, other display medium, etc. The at least one processor 710 is configured to perform the techniques provided herein, and more particularly, to execute the following exemplary computer program product embodiment of the present invention. Alternatively, the logical functions of the computer program product embodiment may be distributed among processors connected through networks or other communication means used to couple processors. The computer program product also executes under various operating systems, such as versions of Microsoft Windows™, Apple Macintosh™, UNIX, etc.

The present invention may be implemented as a computer program product (also referred to as “QD module”) that is developed for and implemented in the Macromedia Flash™ environment as, e.g., a Flash™ client application code module. The QD module in conjunction with a Super-Versatile-Text Display sub-module (also referred to as “SVT module”) (described below) effectively present multimedia information on a display output device.

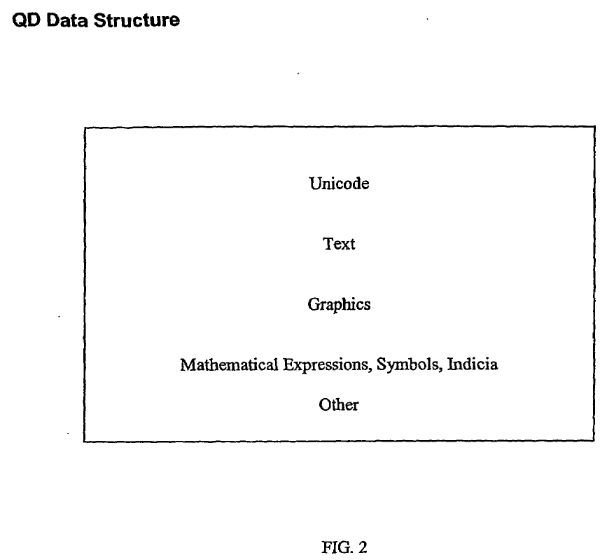

FIG. 2 displays an exemplary data format utilized by the QD module in accordance with the present invention. That the depicted layout and data are necessarily defined by the environment in which they are used will be apparent to those skilled in the art. In one embodiment, the QD data format is implemented as an XML object, an open web standard that is understood by a Flash™ application. The QD data format preferably uses Unicode as the character encoding, which allows for a huge character set, including most languages and math symbols. The QD data format also allows for and intermingles styled text, such as italics, bold, etc., graphics, and mathematical expressions, symbols and other indicia. The graphics may be defined as standard JPEG files or as Flash SWF™ files and can be animated or interactive. Mathematical expressions are defined as MathML, an open standard based on XML, which can be imported and exported by most math software products.

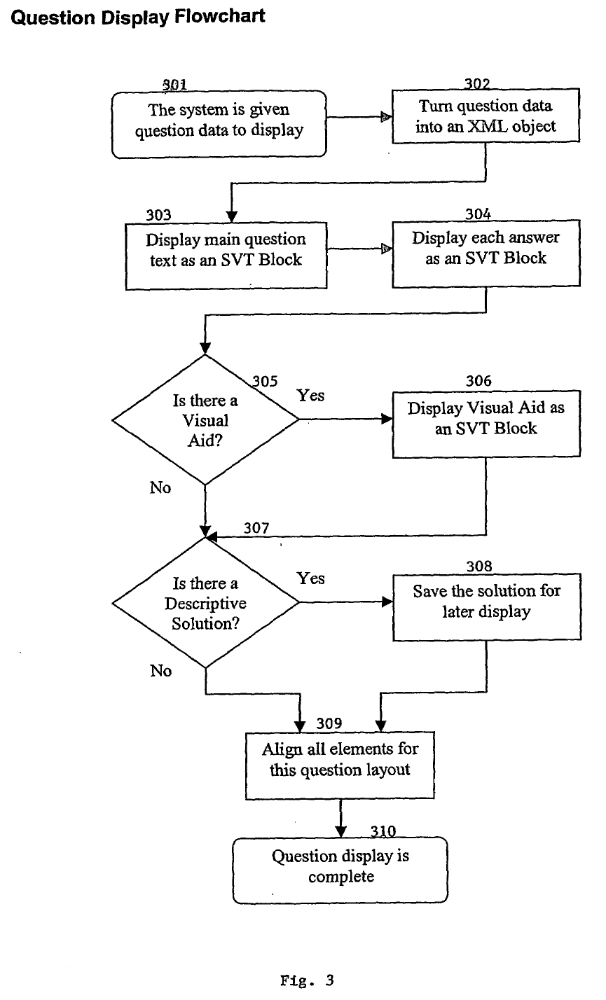

FIG. 3 depicts an exemplary process flow of the QD module in accordance with the present invention.

As shown, at 301, content data, e.g., question data is entered into the system. The content data includes text, styled text, specifications of external data files (containing, e.g., graphics or animations), MathML and other displayable objects. The content data is used to generate main question content and associated answer, Visual Aid (optionally), and Descriptive Solution (optionally) content.

At 302, the system processes the question data and converts said data into an XML tree object. The question data is used to generate text for a main question.

At 303, the system displays the question text as a Flash™ data block.

At 304, the system displays potential answer(s) to the main question as a Flash™ data block;

At 305, the system checks for a Visual Aid related to the main question. As its name suggests, a Visual Aid, graphical illustrates related question concepts. Depending on the results, processing continues to 306 or 307. If there is a Visual Aid, processing continues to 306 and then 307. If there is no Visual Aid, however, processing continues directly to 307.

At 306, the system displays the Visual Aid as a Flash™ data block and processing continues to 307.

At 307 and the system checks for a Descriptive Solution related to the main question. Depending on the results, processing continues to 308 or 309. If there is a Descriptive Solution, processing continues to 308 and then 309. If there is no Descriptive Solution, however, processing continues directly to 309.

At 308, the system saves the Descriptive Solution for later display as a Flash™ data block and processing continues to 307.

At 309, the system aligns all data elements according to a desired layout.

At 310, the system displays the question accordingly.

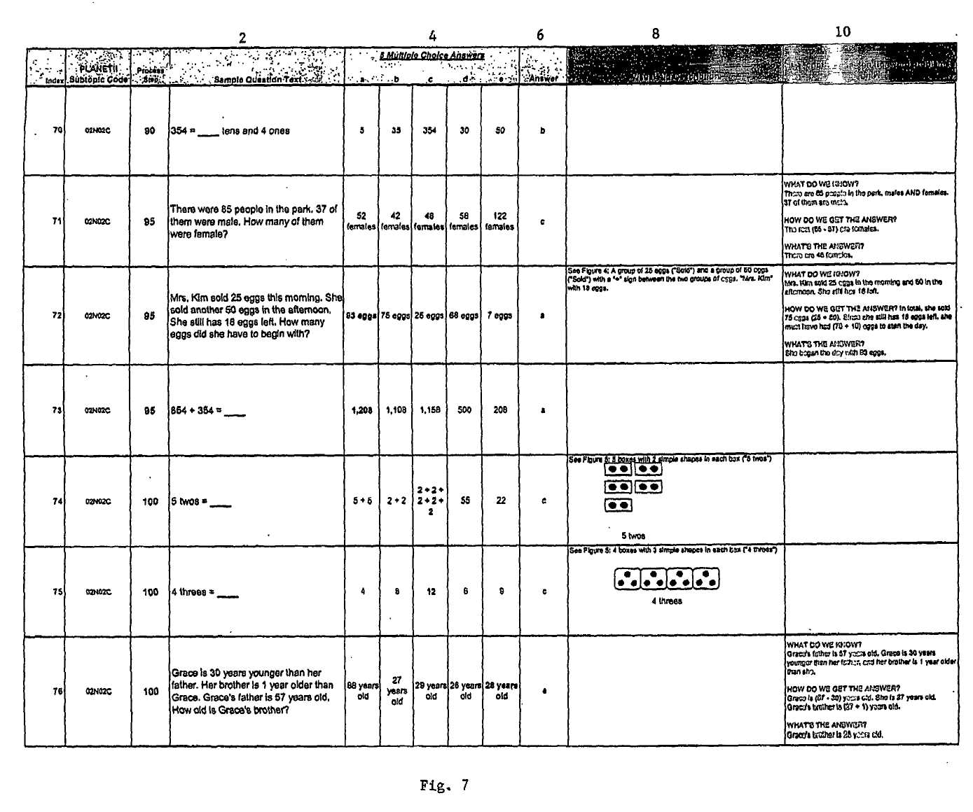

FIG. 7 depicts an exemplary user interface depicting the various elements for display. As shown, the question text data is presented as Display Area 2, the potential answer choice(s) data is presented as Display Area 4, the correct answer data is presented as Display Area 6, the Visual Aid data is presented as Display Area 8 and the Descriptive Solution data is presented as Display Area 10.

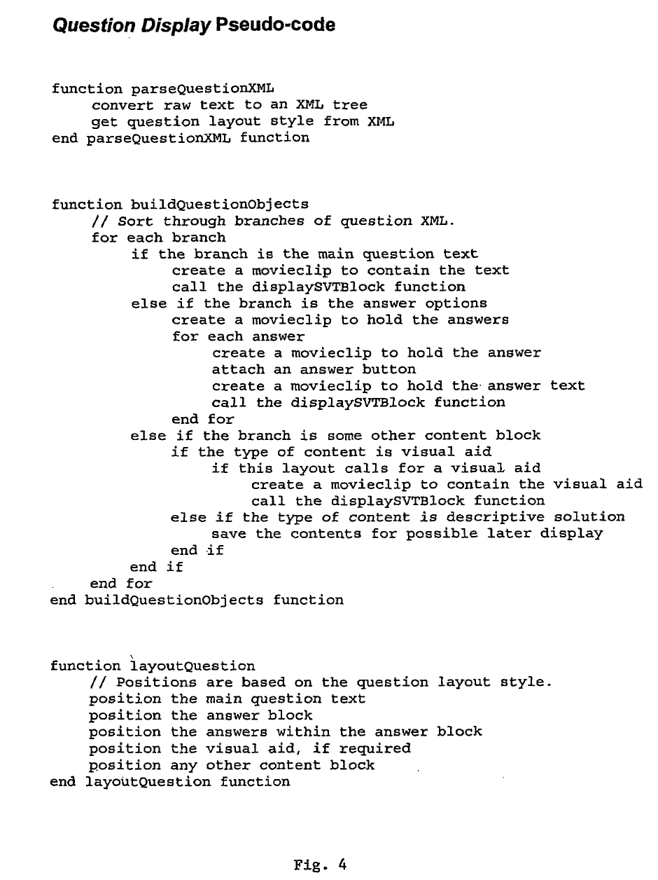

FIG. 4 depicts exemplary pseudo code for implementing the QD module (also reproduced below).

QD Pseudo-code

```
function parseQuestionXML
    convert raw text to an XML tree
    get question layout style from XML
end parseQuestionXML function
function buildQuestionObjects
    // Sort through branches of question XML.
    For each branch
        if the branch is the main question text
            create a movieclip to contain the text
            call the displaySVTBlock function
        else if the branch is the answer options
            create a movieclip to hold the answers
            for each answer
                create a movieclip to hold the answer
                attach an answer button
                create a movieclip to hold the answer text
                call the displaySVTBlock function
            end for
        else if the branch is some other content block
            if the type of content is visual aid
                if this layout calls for a visual aid
                    create a movieclip to contain the
visual aid
                    call the displaySVTBlock function
            else if the type of content is descriptive
solution
                save the contents for possible later
display
            end if
        end if
    end for
end buildQuestionObjects function
function layoutQuestion
// Positions are based on the question layout style.
    Position the main question text
    position the answer block
    position the answers within the answer block
    position the visual aid, if required
    position any other content block
end layoutQuestion function
```

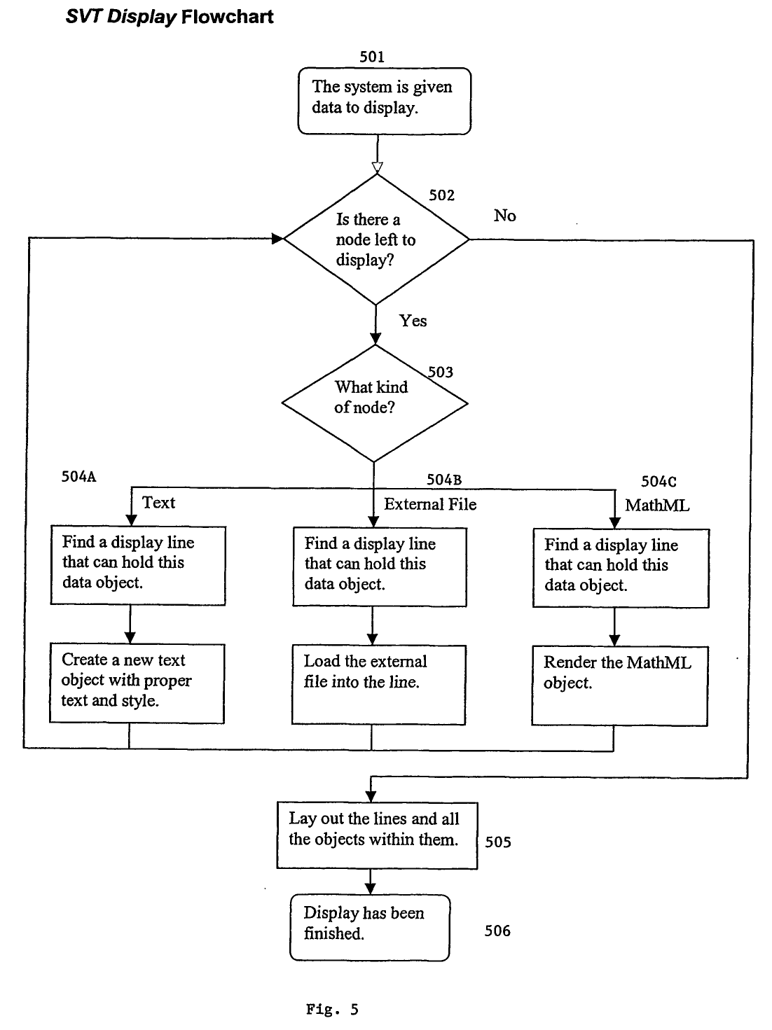

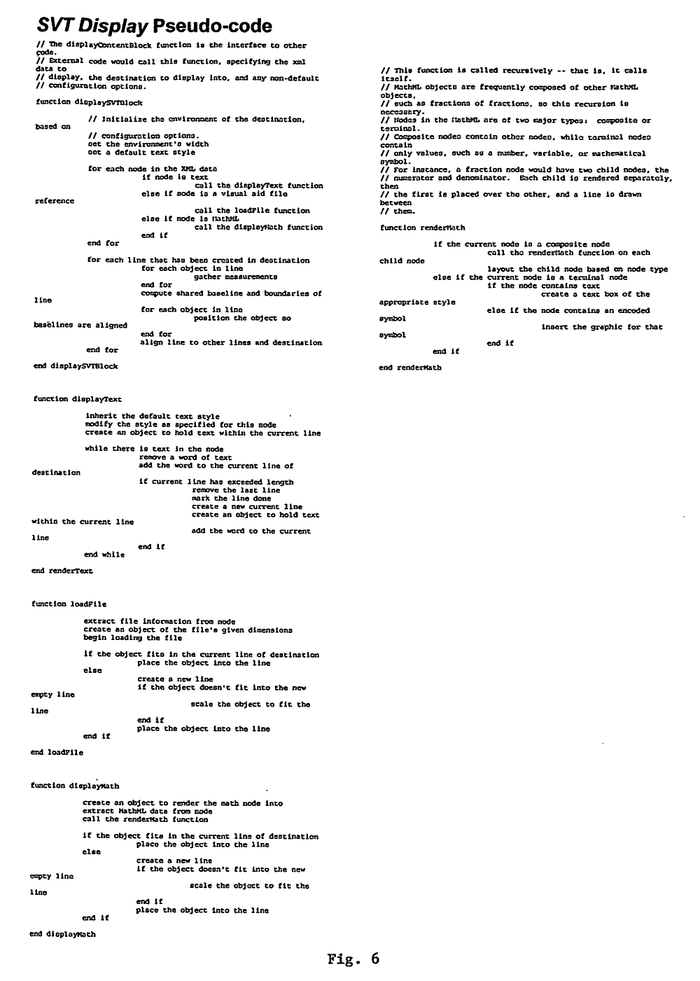

FIGS. 5 and 6 depict additional features of the QD module in accordance with the present invention. Specifically, FIG. 5 illustrates an exemplary process flow of the Super-Versatile-Text Display module or SVT module. The QD module interacts with (calls) the SVT module to visually render the QD content data.

As shown, at 501, content data is entered into the system. This content data is displayed as follows:

At 502, the system traverses the XML tree to determine if content (node) is left to display. If yes, processing continues to 503. If no, processing continues to 505.

At 503, the system determines the kind of content left to display. Depending on the results, the system follows alternate paths. If the content is text, processing continues to 504A. If the content is an external file, processing continues to 504B. If the content is MathML, processing continues to 504C.

At 504A, the system locates a display line that can hold the text data object. The system then creates a new text object having the appropriate text and style format and processing returns to 502.

At 504B, the system locates a display line that can hold the external file data object. The system then loads the external file onto the line and processing returns to 502.

At 504C, the system locates a display line that can hold the MathML data object. The system then renders the MathML object and processing returns to 502.

When there is no node-data content left to display, processing continues to 505

At 505, the system formats the lines and all data objects within them and displays the same at 506.

FIG. 6 depicts exemplary pseudo code for implementing the SVT module (also reproduced below).

SVT Display Pseudo-code

```
// The displayContentBlock function is the interface to
other code.
// External code would call this function, specifying the
xml data to
// display, the destination to display into, and any non-
default
// configuration options.
Function displaySVTBlock
    // Initialize the environment of the destination,
based on
    // configuration options.
    Set the environment's width
    set a default text style
    for each node in the XML data
        if node is text
            call the displayText function
        else if node is a visual aid file reference
            call the loadFile function
        else if node is MathML
            call the displayMath function
        end if
    end for
    for each line that has been created in destination
        for each object in line
            gather measurements
        end for
        compute shared baseline and boundaries of line
        for each object in line
            position the object so baselines are
aligned
        end for
        align line to other lines and destination
    end for
end displaySVTBlock
function displayText
    inherit the default text style
    modify the style as specified for this node
    create an object to hold text within the current line
    while there is text in the node
        remove a word of text
        add the word to the current line of destination
        if current line has exceeded length
            remove the last line
            mark the line done
            create a new current line
            create an object to hold text within the
current line
            add the word to the current line
        end if
    end while
end renderText
function loadFile
    extract file information from node
    create an object of the file's given dimensions
    begin loading the file
    if the object fits in the current line of destination
        place the object into the line
    else
        create a new line
        if the object doesn't fit into the new empty
line
            scale the object to fit the line
        end if
        place the object into the line
    end if
end loadFile
function displayMath
    create an object to render the math node into
    extract MathML data from node
    call the renderMath function
    if the object fits in the current line of destination
        place the object into the line
    else
        create a new line
        if the object doesn't fit into the new empty
line
            scale the object to fit the line
        end if
        place the object into the line
    end if
end displayMath
// This function is called recursively - that is, it calls
itself.
// MathML objects are frequently composed of other MathML
objects,
// such as fractions of fractions, so this recursion is
necessary.
// Nodes in the MathML are of two major types: composite
or terminal.
// Composite nodes contain other nodes, while terminal
nodes contain
// only values, such as a number, variable, or mathematical
symbol.
// For instance, a fraction node would have two child
nodes, the
// numerator and denominator. Each child is rendered
separately, then
// the first is placed over the other, and a line is drawn
between
// them.
Function renderMath
    if the current node is a composite node
        call the renderMath function on each child node
        layout the child node based on node type
    else if the current node is a terminal node
        if the node contains text
            create a text box of the appropriate
style
        else if the node contains an encoded symbol
            insert the graphic for that symbol
        end if
    end if
end renderMath
```

### External (Public) Function Definitions

This section lists the external functions of the Question Display module. While there is no strict object-oriented public/private status here, these are the only functions that should be called by outside code. Unless specified, each function has no return value.

init(initObj)

This function should be called once, before calling any of the other functions below. It initializes the QD environment with various constants, including font settings and width and height measurements.

### Arguments

initObj An object containing any named values to override configuration options

displayQuestion(question, return_mc, return_func)

This function displays a question. When display is complete, it calls the specified return function.

### Arguments

question The question data, in well-formed XML text.

return_mc [optional] The context in which return_func will be called on completion.

return_func [optional] The function that will be called within return_mc.

removeQuestion( )

This function removes the displayed question.

### Arguments

(none)

activateAnswers(notify_mc, notify_func)

This function activates the answer options, making them interactive for the user. When an answer is selected, the specified notification function is called with two arguments: the letter of the user's selected answer, and the correct answer.

### Arguments

notify_mc The context in which notify_func will be called on completion.

notify_func The function that will be called within notify_mc.

deactivateAnswers( )

Deactivates all answer options, so that they do no allow user selection.

### Arguments

(none)

showUserAnswer(userAnswer, showCorrect)

This function marks the answer specified in userAnswer, showing whether the selection was correct or incorrect. If showCorrect is set to true and the user's answer was incorrect, the correct answer is also be revealed.

### Arguments

userAnswer The letter of the answer the user has selected.

showCorrect A true/false flag, telling whether to reveal the correct answer.

getCorrectAnswer( )

Returns the letter of the correct answer for a displayed question.

### Arguments

(none)

showCorrectAnswer( )

Reveals to the user the correct answer to a displayed question.

### Arguments

(none)

getAnswerArray( )

Returns an array of the letters of all the answer options. This is useful for allowing user selection of an answer via the keyboard.

### Arguments

(none)

isSolution( )

This function returns true if there is a descriptive solution available for this question, and false otherwise.

### Arguments

(none)

displaySolution(dest_mc, destWidth, return_mc, return_func)

This function renders the descriptive solution for the question, if it exists. The solution is rendered in the specified movieclip, at the specified width. Once the render is complete, the return function is called.

### Arguments

dest_mc The movieclip to render the descriptive solution into.

destWidth The width in pixels of dest_mc's display area.

return_mc [optional] The context in which return_func will be called on completion.

return_func [optional] The function that will be called within return_mc.

displayXMLBlock(svt_xml, dest_mc, destWidth, return_mc, return_func)

This function renders an XML object of question data (also called an SVT Block) into the specified movieclip, at the specified width. Once the render is complete, the return function is called.

### Arguments

svt_xml An XML object containing a valid chunk of SVT data.

dest_mc The movieclip to render the descriptive solution into.

destWidth The width in pixels of dest_mc's display area.

return_mc [optional] The context in which return_func will be called on completion.

return_func [optional] The function that will be called within return_mc.

displayTextBlock(svtText, dest_mc, destWidth, return_mc, return_func)

Like displayXMLBLock( ), this function renders an SVT Block into the specified movieclip, at the specified width. However, the SVT Block should be passed as plain text, rather than as an XML object. Once the render is complete, the return function is called.

### Arguments

svtTextXML text describing a valid chunk of SVT data.

dest_mc The movieclip to render the descriptive solution into.

destWidth The width in pixels of dest_mc's display area.

return_mc [optional] The context in which return_func will be called on completion.

return_func [optional] The function that will be called within return_mc.

### Internal (Private) Function Definitions

This section lists the internal functions of the QD module. While there is no strict object-oriented public/private status here, these functions should not be called by outside code. Any interaction should occur through the External Functions listed above. Again, unless specified, each function has no return value)

parseQuestionXML(rawText)

This function converts the source text for the question into an XML object. It also checks the XML for the question's layout, which is required before question rendering can begin. The XML object and layout value are both stored within the internal question movieclip.

### Arguments

rawText A text string containing the well-formed XML for a full question.

buildQuestionObjects( )

This function sorts through the question XML object, extracting the question text and answers, as well as any visual aid, descriptive solution, or other content. Movieclips are created for the question text, answers and visual aid, and their SVT blocks are rendered, via the displaySVT( ) function. The descriptive solution, if present, is saved for later display.

### Arguments

(none)

displaySVT(svt_xml, svt_mc)

This function takes an SVT Block and renders it into the specified SVT environment. The SVT Block is an XML object, and the SVT environment is a movieclip containing the settings and configuration information for SVT display.

### Arguments

svt_xml An XML object containing an SVT Block.

svt_mc The SVT environment movieclip to render the SVT Block into.

getDisplayLine(svt_mc)

This function returns a reference to the current line (a movieclip) in an SVT environment movieclip. The current line will have at least some room for additional content (text, graphics, rendered MathML). If the last existing line is full, or there is no current line, this function will create a new one.

### Arguments

svt_mc An SVT environment movieclip.

endDisplayLine(svt_mc)

This function marks the current display line in the SVT Environment as complete, so that the next call to getDisplayLine( ) will return a new line. This is useful for line breaks, or when a content object must wrap to the next line.

### Arguments

svt_mc An SVT environment movieclip.

displayVisualAid(va_xml, svt_mc)

This function renders a visual aid item into an SVT Environment. The visual aid, usually a SWF or JPEG, will be loaded from a separate file. The height and width of the object are specified in the XML, so layout can occur without waiting for the load to complete. (Loading is accomplished using the piiloader module.)

### Arguments

va_xml An XML node from an SVT Block, containing a visual aid.

svt_mc An SVT environment movieclip.

processVisualAid(returnID, va_mc)

This function is called from the piiLoader module when a visual aid object has completed loading. It completes the processing of the loaded file, verifying that it fits within the dimensions specified in the XML node of the SVT Block.

### Arguments

returnID A piiloader Load D, uniquely identifying this load.

va_mc A movieclip containing the loaded file.

displayMathML(math_xml, svt_mc)

This function renders a MathML portion of an SVT Block into a single object. The rendering of individual MathML elements is handled by the renderMathML( ) function. This function handles the allocation of lines within the SVT Environment, wrapping to the next line if the MathML object is too wide.

### Arguments

math_xml An XML node from an SVT Block, containing MathML data.

svt_mc An SVT environment movieclip.

renderMathML(math_xml, box_mc, ref_tf)

This function renders individual MathML elements into movieclips containing text and library symbols. The rendering is handled recursively, so that it calls itself to render any MathML elements nested within the main element. (For instance, a the fraction MathML element contains two other elements, representing numerator and denominator.) This function takes as arguments a node of MathML data, a movieclip to render that data into, and a text format. The function returns a reference to the movieclip it creates.

### Arguments

math_xml An XML node containing MathML data.

box_mc A movieclip to create the new movieclip inside of.

ref_tf A text format object, to be used in rendering this object's text.

displayTextItem(rawText, svt_mc)

This function handles the display of plain and styled text objects from SVT Blocks. It takes a text string and renders it inside the SVT Environment in the current text format, splitting the text and wrapping to multiple lines as necessary.

### Arguments

rawText A text string.

svt_mc An SVT environment movieclip.

drawBorder(a_mc, color, bwidth, bheight)

This function draws a border within a movieclip, using the Flash line-drawing tools. If bwidth and bheight are not specified, the measured width and height of the movieclip will be used instead. This function is used extensively within the rendering functions to force certain measurements onto a movieclip. For instance, a loaded SWF file might not take up the full space it is meant to occupy, confusing layout. An invisible border greatly eases such layout computations. (Note that the line-drawing functions are prone to overwrite any existing lines within the movieclip.)

### Arguments

a_mc The movieclip to draw the border into.

color The color to draw the border with. (Only visible while debugging.)

bwidth [optional] The width to draw the border.

bheight[optional] The height to draw the border.

layoutQuestion( )

This function completes the layout of the previously-built question objects. The question text, answers and visual aid are positioned according to their sizes and the layout style specified in the question XML.

### Arguments

(none)

Having now described one or more exemplary embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

Moreover, the techniques presented herein may be implemented in hardware or software, or a combination of the two. In one embodiment, the techniques are implemented in computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language. In one embodiment, the present invention is implemented in the ActionScript programming language for use in the Macromedia Flash™ environment. The program code uses Macromedia Flash MX™ to publish, Macromedia Flash Player™ (e.g., Version 6, Release 48, or better) to execute and utilizes the Macromedia piiLoader and timeQueue code modules.

Each such computer program is preferably stored on a storage medium or device (e.g., CD-ROM, NVRAM, ROM, hard disk, magnetic diskette or carrier wave) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

The description of the exemplary embodiment herein assumes knowledge of Macromedia Flash™ and ActionScript™ programming language and a general understanding of programming documentation conventions. Understanding of layout and design issues, such as page layout for the web or for print, and especially as regards the layout of mathematical expressions, will also be useful.

Additional aspects and/or features of the present invention include: the code attempts to provide general solutions as much as possible, but may be specific to the font and layout size of current implementation. If the font or another part of the display environment is changed radically, spacing within and between lines may be tweaked, accordingly.

Preferably, math symbols, whether by named entity or Unicode characters, are usable as follows: both named entities and coded characters are expected to exist alone within the XML terminal tags. That is, in one embodiment of the present invention, <mn>5</nm><mn>πx</mn> is valid while <mn>5π</mn> is not.

Finally, an embodiment of the present invention having potential commercial success is integrated in the Planetii™ Math System™, an online math education software product, available at <http://www.planetii.com/home/>.

What is claimed is:

1. A display system for multimedia content data comprising Mathematical Markup Language (MathML) data, said system comprising:
a display medium having a plurality of display lines for rendering multimedia content data thereon;
a processor associated with said display medium and configured to:
receive said multimedia content data comprising textual, MathML, and external file indicia data;
parse said received multimedia content data to derive said textual, MathML and external file indicia data;
categorize said textual, MathML and file data according to a data type; wherein said textual data is defined as a TEXT data type, said MathML data is defined as a MATHML data type and said external file indicia data is defined as a FILE data type;
store said derived and categorized textual, MathML and external file indicia data as a tree having a root node and a plurality of offspring nodes that define left and right subtrees, said root node and said offspring nodes each having one of said derived textual, MathML and external file indicia data and respective data type association;
define a traverse procedure that includes:
visiting a node of said tree,
determining the data type of said node;
displaying said node data in accordance with said data type, wherein:
if the data type is TEXT: create a text object having said textual node data and locate a display line to display said text object in accordance with predetermined formatting conventions,
if the data type is FILE: create a file object having said external file indicia node data and locate a display line to load and display said file object in-line with previously rendered text and in accordance with predetermined formatting conventions,
if the data type is MATHML, create a MathML data object having said stored MathML node data and locate a display line to display said MathML data object in-line with previously rendered text and in accordance with predetermined formatting conventions,
applying said traverse procedure upon the left subtree of said visited node;
applying said traverse procedure upon the right subtree of said visited node; and
applying said traverse procedure upon said root node such that said root node is the first visited node.

2. A system as in claim 1 wherein said processor further categorizes said MathML data as MATHML COMPOSITE and MATHML TERMINAL data types;
stores said categorized MathML data as a MathML tree having a root node and a plurality of offspring nodes that define left and right subtrees of said MathML tree, said root node and said offspring nodes of said MathML tree each having one of said derived MathML data and respective data type association;
defines a second traverse procedure that includes:
visiting a node of said MathML tree,
determining the MathML data type of said MathML tree node,
displaying said MathML tree node data in accordance with said data type, wherein:
if the data type is MATHML COMPOSITE: create a MathML data object having said stored MathML composite node data and locate a display line to display said MathML data object in-line with previously rendered text and in accordance with predetermined formatting conventions, and,
if the data type is MATHML TERMINAL: create a MathML data object having said stored MathML node terminal node data and locate a display line to display said MathML data object in-line with previously rendered text and in accordance with predetermined formatting conventions,
applying said second traverse procedure upon the left sub-MathML tree of said visited MathML tree node;
applying said second traverse procedure upon the right sub-MathML tree of said visited MathML tree node; and
applying said second traverse procedure upon said root node of said MathML tree such that said root node is the first visited node of the MathML tree.

3. The system as in claim 1 or 2 wherein said multimedia content data comprises Markup Language data.

4. The system as in claim 3 wherein said Markup Language data comprises Extensible Markup Language (XML) data.

5. The system as in claim 1 or 2 wherein said external file indicia data comprises information associated with data files comprising graphics, video, animation, other displayable assets or a combination thereof.

6. The system as in claim 4 wherein said data files are Macromedia or Flash-compatible files.

7. A method of displaying multimedia content data comprising Mathematical Markup Language (MathML) data, said method comprising:
providing a display medium having a plurality of display lines for rendering multimedia content data thereon;
receiving said multimedia content data comprising textual, MathML, and external file indicia data;
parsing said received multimedia content data to derive said textual, MathML and external file indicia data;
categorizing said textual, MathML and file data according to a data type; wherein said textual data is defined as a TEXT data type, said MathML data is defined as a MATHML data type and said external file indicia data is defined as a FILE data type;
storing said derived and categorized textual, MathML and external file indicia data as a tree having a root node and a plurality of offspring nodes that define left and right subtrees, said root node and said offspring nodes each having one of said derived textual, MathML and external file indicia data and respective data type association;
defining a traverse procedure that includes:
visiting a node of said tree,
determining the data type of said node;
displaying said node data in accordance with said data type, wherein:
if the data type is TEXT: create a text object having said textual node data and locate a display line to display said text object in accordance with predetermined formatting conventions,
if the data type is FILE: create a file object having said external file node data and locate a display line to load and display said file object in-line with previously rendered text and in accordance with predetermined formatting conventions,
if the data type is MATHML, create a MathML data object having said stored MathML node data and locate a display line to display said MathML data object in-line with previously rendered text and in accordance with predetermined formatting conventions,
applying said traverse procedure upon the left subtree of said visited node;
applying said traverse procedure upon the right subtree of said visited node; and
applying said traverse procedure upon said root node such that said root node is the first visited node.

8. The method as in claim 7 wherein said method further comprises categorizing said MathML data as MATHML COMPOSITE and MATHML TERMINAL data types;
storing said categorized MathML data as a MathML tree having a root node and a plurality of offspring nodes that define left and right subtrees of said MathML tree, said root node and said offspring nodes of said MathML tree each having one of said derived MathML data and respective data type association;
defining a second traverse procedure that includes:
visiting a node of said MathML tree,
determining the MathML data type of said MathML tree node,
displaying said MathML tree node data in accordance with said data type, wherein:
if the data type is MATHML COMPOSITE: create a MathML data object having said stored MathML composite node data and locate a display line to display said MathML data object in-line with previously rendered text and in accordance with predetermined formatting conventions, and,
if the data type is MATHML TERMINAL: create a MathML data object having said stored MathML node terminal node data and locate a display line to display said MathML data object in-line with previously rendered text and in accordance with predetermined formatting conventions,
applying said second traverse procedure upon the left sub-MathML tree of said visited MathML tree node;
applying said second traverse procedure upon the right sub-MathML tree of said visited MathML tree node; and
applying said second traverse procedure upon said root node of said MathML tree such that said root node is the first visited node of the MathML tree.

9. The method as in claim 7 or 8 wherein said multimedia content data comprises Markup Language data.

10. The method as in claim 9 wherein said Markup Language data comprises Extensible Markup Language (XML) data.

11. The method as in claim 7 or 8 wherein said external file indicia data comprises information associated with data files comprising graphics, video, animation, other displayable objects or a combination thereof.

12. The method as in claim 11 wherein said data files are Macromedia Flash or Flash-compatible files.

13. A user interface for presenting question and answer multimedia data comprising mathematical MathML content, said system comprising:
a processor configured to:
receive said multimedia data comprising textual, MathML and external file data;
parse said received multimedia data to derive said textual, MathML and external file data;
generate question content and associated answer, visual aid and descriptive solution content based on said derived textual, MathML and external file data;
display first, second, third and fourth display containers on said display device, said first display container including a presentation area for displaying said question content; said second display container including a presentation area for displaying said answer content; said third display container including a presentation area for displaying said visual aid content; said fourth display container including a presentation area for displaying said descriptive solution content; and
wherein for each of said first, second, third and fourth display containers said MathML and external file data of said container content are displayed in-line with said textual data of said container content.

14. The user interface as in claim 13 wherein said external file data includes graphics, video, animation, other displayable objects or any combination thereof.

15. The user interface as in claim 13 or 14 wherein said multimedia data comprises Markup Language data.

16. The user interface as in claim 15 wherein said Markup Language data comprises Extensible Markup Language (XML) data.
